(19) United States
(12) Patent Application Publication
(10) Pub. No.: US 2025/0269517 A1
(43) Pub. Date: Aug. 28, 2025

(54) MULTIMODAL SHARED TELEROBOTIC SYSTEM AND METHOD FOR THREE-ARM SPACE ROBOT

(71) Applicant: SOUTHEAST UNIVERSITY, Jiangsu (CN)

(72) Inventors: Aiguo SONG, Jiangsu (CN); Mutian HE, Jiangsu (CN); Jianzhi WANG, Jiangsu (CN); Huijun LI, Jiangsu (CN)

(73) Assignee: SOUTHEAST UNIVERSITY, Jiangsu (CN)

(21) Appl. No.: 19/015,670

(22) Filed: Jan. 10, 2025

Related U.S. Application Data
(63) Continuation of application No. PCT/CN2024/081061, filed on Mar. 12, 2024.

(30) Foreign Application Priority Data
Feb. 26, 2024 (CN) 202410208049.X

(51) Int. Cl. B25J 9/00; B25J 9/16; B25J 13/00; B25J 13/02; B25J 19/02

(52) U.S. Cl. CPC B25J 9/0084; B25J 9/1633; B25J 9/1676; B25J 9/1689; B25J 13/003; B25J 13/025; B25J 19/023; G05B 2219/39001; G05B 2219/45085

(57) ABSTRACT

A multimodal shared telerobotic system and method for a three-arm space robot, the system at least includes a local-site system, a communication module, and a remote-site system, where the local-site system includes two force-feedback haptic devices for left and right hands, a microphone array, and upper computer software; the remote-site system includes two robotic arms provided with end-effectors, an observation arm with a stereo camera installed at an end thereof, two force sensors, a vision unit and lower computer software; an operator can control the two robotic arms of the robot outside a cabin for performing operations, and control the observation arm to obtain a better local view; and a multimodal telerobotic control method of pose control, voice control, and force control is integrated with the robot's autonomous control through a shared control algorithm.

### CROSS-REFERENCE TO RELATED APPLICATION

The present application is a continuation application of PCT application No. PCT/CN2024/081061, filed Mar. 12, 2024, which claims priority to Chinese patent application No. 202410208049.X, filed on Feb. 26, 2024, the entire contents of which are incorporated herein by reference.

### TECHNICAL FIELD

The present disclosure belongs to the technical field of space telerobotic control, and mainly relates to a multimodal shared telerobotic system and method for a three-arm space robot.

### BACKGROUND

In recent years, China's aerospace industry has developed rapidly. As China's space station enters a stable in-orbit operation phase, astronauts need to carry out more and more extravehicular activities such as equipment maintenance, replacement of consumables and fuel. However, the extravehicular activities face many challenges, including long preparation period of time, frequent operations, high work intensity, wide range of operations, and the like. Furthermore, there are inherent safety risks during the extravehicular activities. Therefore, it is necessary to develop a space robot to replace the astronauts in performing the extravehicular activities outside a cabin. But the extravehicular activities, such as in-orbit assembly, in-orbit installation, and replacement of solar cells, are always complex and precise. Traditional single-arm robots cannot meet these demands, so there is an urgent need to develop a space robot having two arms or even multiple arms capable of coordinating with one another to perform the extravehicular activities.

In addition, extravehicular activities are always subjected to a complex lighting environment and have diverse task requirements, it is difficult to develop a fully autonomous space robot system suitable for the extravehicular activities based on a current level of automation and sensor technology. An existing primary solution is to develop a telerobotic system that can be completely controlled by an operator to perform complex space operations, which brings forward higher requirements for operating experience of the operator and imposes physical and mental burden on the operator, especially when controlling a robot system having two or more robotic arms, in which case, the operator needs to conduct multitasking, that is, simultaneously controlling position, posture and contact force between ends and environments of robotic arms while paying attention to various information from the robot. Therefore, human-robot shared teleoperation has emerged as an effective method to solve the above problems.

### SUMMARY

In view of defects in the prior art, the present disclosure provides a multimodal shared telerobotic system and method for a three-arm space robot, which at least includes a local-site system, a communication module, and a remote-site system, where the local-site system includes two force-feedback haptic devices for left and right hands, a microphone array, and upper computer software; the remote-site system includes two robotic arms provided with end-effectors, an observation arm with a stereo camera installed at an end thereof, two force sensors, a vision unit and lower computer software; an operator can use the two force-feedback haptic devices inside a spacecraft cabin to separately control the two robotic arms of the robot outside the cabin for performing operations, and control the observation arm through a voice command to obtain a better local view; in the present disclosure, a multimodal telerobotic control method of pose control, voice control, and force control is integrated with the robot's autonomous control through a shared control algorithm, and dimensions and weights of an outputted command of each control method that are mapped to a joint space of the robotic arms are dynamically distributed according to the operator's needs, such that position, posture and contact force of the robot-arms are realized through a human-robot shared control, allowing the operator to focus on controlling the robotic arms to perform critical and difficult operations, and the robot to autonomously complete simpler tasks, therefore, workload of the operator is reduced, and the accuracy and efficiency of teleoperation are improved. The local-site system provides multimodal feedback haptic, visual, and auditory sensations, which can improve the operator's sense of presence, control accuracy and comfort in unstructured environments.

In order to achieve the above objectives, the present disclosure adopts the following technical solutions: a multimodal shared telerobotic system for a three-arm space robot, which at least includes a local-site system, a communication module, and a remote-site system;
the local-site system includes two force-feedback haptic devices for left and right hands, a microphone array, and upper computer software; and the upper computer software includes virtual simulation human-robot interaction software, a haptic device drive module, and a voice recognition module;
the remote-site system includes a robotic arm, an observation arm, force sensors, a vision unit and lower computer software, the robotic arm has two and is provided with a gripper at an end thereof; a stereo camera is installed at an end of the observation arm; the lower computer software at least includes a force control algorithm, a pose control algorithm, a target recognition algorithm, an autonomous control algorithm and a shared control algorithm; and the vision unit is configured to provide a local-site system with visual information about a surrounding environment of a remote-site robot, and support target recognition of the autonomous control algorithm; and
the communication module is configured to construct a medium-short distance and low-latency wireless local area network, so as to achieve wireless communication between the local-site system and the remote-site system.

As an improvement of the present disclosure, in the local-site system:
the force-feedback haptic devices are configured to collect pose information inputted by an operator, receive data from the force sensors and give feedback of three-dimensional force to the operator;
the microphone array is configured to collect audio signals of the operator;
the virtual simulation human-robot interaction software includes a real-time rendered robot three-dimensional model, teleoperation mapping parameter adjustment, and collision detection and warning functions, which can provide the operator with feedback information and an interactive interface, and output an interactive command;
the haptic device drive module is configured to solve the inputted pose information of the operator and output the same as an operation command; and
the voice recognition module is configured to analyze and output a voice command of the operator.

As an improvement of the present disclosure, in the lower computer software:
the force control algorithm is used to control action force between the robotic arms and the surrounding environment, and to output a force control command q_{f} according to a force signal setting value in the interactive command outputted by the local-site system and data from the force sensor;
the pose control algorithm is used to control poses of the robotic arms and the observation arm, and is capable of reading a haptic device operation command, the voice command and the interactive command outputted by the local-site system, and outputting a pose control command qₚᵣ;
the target recognition algorithm is used to identify a target object in the environment and determine pose and contour of the target object;
the autonomous control module is used to performs autonomous path planning based on target recognition result, and to generate a robot's autonomous command qₐ using a bidirectional rapidly-exploring random tree; and
the shared control algorithm is used to select the pose control command qₚᵣ or the force control command q_{f} as an operator's teleoperation command qₕ according to the interactive command, and integrate the operator's teleoperation command with the robot's autonomous command qₐ to obtain a fusion command q_{c}; and a dynamic weight distributor is capable of dynamically distributing dimensions and weights of an outputted command of each method that is mapped to a joint space of the robotic arms through the interactive command, so as to realize human-robot shared control of position, posture and contact force of the robotic arms.

As another improvement of the present disclosure, the local-site system further includes an incremental control module, a teleoperation mapping parameter adjustment module, and a robotic arm collision detection and warning module;
the incremental control module enables and controls movements of the robotic arms through buttons on the handles of the force-feedback haptic devices;
the teleoperation mapping parameter adjustment module is configured to adjust locate-site and remote-site position ratio mapping parameters and force mapping parameters, and adjust movement step sizes of the robotic arms and magnitude of feedback force provided by the force-feedback haptic devices; and
the robotic arm collision detection and warning module is configured to detect potential risks of collision in real time between the robotic arms, as well as between the robotic arms and the robot platform, during the movements of the robotic arms, and to issue a warning.

As another improvement of the present disclosure, when an operator controls a remote-site robot with two robotic arms and one observation arm to perform tasks through local-site and remote-site systems, a lower computer outputs control commands of three methods, such as posture control, force control and autonomous control, to a shared control algorithm to realize a control of the robotic arms;
when a pose control is performed, a command outputted by the local-site system can be read in real time, the command is parsed into a Cartesian target pose x_{d} of an end of each of the robotic arms via a local-remote operation space mapping, a current joint angle qₜ of each of the robotic arms is then obtained, a current Cartesian pose xₜ of the end of each of the robotic arms through forward kinematics, and an error term e(t)=x_{d}−xₜ is obtained; the error item e(t) is inputted into a PID controller to iterate and obtain a pose u(t), a new joint angle qₜ₊₁ of each of the robotic arms is obtained through inverse kinematics of an iterative pose u(t); forward kinematics is performed in a next cycle to obtain xₜ₊₁, an error between it and a target pose x_{d} is calculated, the error term is inputted into the PID controller to form a closed loop of control, and a pose control command qₚᵣ after N iterations is obtained; and
when a force control is performed, the operator sets a target six-dimensional force signal F_{d} for each of the robotic arms through the local-site system, reads a current force signal Fₜ of the force sensor at the end of each of the robotic arms, calculates an error term between the F_{d} and the Fₜ and inputs the error term into the PID controller to generate a iterative force signal Fₑ, and obtain a force control command q_{f} through the dynamic model; and in a next cycle, the operator calculates an error between a force data signal Fₜ₊₁ from each of the force sensors and the F_{d} in a next cycle substitutes the error term into the PID controller, combining a current Jacobian matrix J^{T}(q) of each of the robotic arms to form a closed loop of control, similar to the pose control, and obtains a new force control command q_{f+1}; and
when an autonomous control is performed, a pose at the end of each of the robotic arms is taken as a root node of a first extended random tree, a pose of the target is determined according to recognition results of a target recognition algorithm, and the pose of the target is taken as a root node of a second extended random tree; alternating bidirectional expansion of the two extended random trees is performed using a same step size through a random sampling method, sub-nodes are added alternately until the two trees meet, at which point a path planning algorithm converges; and after the path planning algorithm converges, backtrack is performed along the root nodes at an intersection of the two extended random trees to identify a valid path, and inverse kinematics of a series of sub-nodes is performed on the valid path to obtain a value of a joint angle in a joint space of the robotic arms, which is outputted as an autonomous command qₐ.

As another improvement of the present disclosure, for the three methods integrating the pose control, the force control and the autonomous control, the shared control algorithm includes the following steps:
step S1: selecting either the pose control command qₚᵣ or the force control command q_{f} via the interactive command as the teleoperation command qₕ according to an operation mode set by the operator;
step S2: sending a local-site interactive command to a dynamic weight distributor to calculate a value of each diagonal element of a weight matrix S according to target recognition result Cᵢ and a type of operation task, so as to realize dynamic updating of shared control weights during an operation process;
step S3: fusing the teleoperation command qₕ of the operator and the autonomous command qₐ of the robot to obtain a final fusion command q_{c} according to calculation results S of the dynamic weight distributor.

As another improvement of the present disclosure, the weight matrix S in the step S2 is determined by the dynamic weight distributor:
when the target recognition algorithm does not detect the target object, or the target recognition result Cᵢ is lower than a recognition threshold C_{L}, the dynamic weight distributor sets S as an identity matrix, in which case, the operator controls pose and force of the robotic arms using the haptic devices or via keyboard interaction, and controls pose of the observation arm via a voice command;
when the target recognition result Cᵢ is greater than or equal to the recognition threshold C_{L}, a value of S is calculated via the dynamic weight distributor based on a task type through the interactive command set by the operator in the local-site system, such that position, posture and contact force of human-robot shared control are realized; and
when the target recognition result Cᵢ is greater than or equal to the recognition threshold C_{L}, and S is set to a zero matrix, such that the robot fully and autonomously controls the pose and force of the robotic arms.

Compared with the prior art, the present disclosure has the following beneficial effects:

(1) Compared with the traditional single-arm robots, the three-arm space robot provided in the present disclosure has the advantages of higher degree of freedom, a larger workspace, and greater flexibility in multi-arm shared operations, which can meet the needs of extravehicular operations. In addition, the observation arm provides a better local view, facilitating precise operations by the operator.
(2) A hybrid control strategy allows the operator to directly control the system, leveraging his/her judgment and decision-making ability, while ensuring that the robot has a certain degree of autonomy, and the robot can help the operator complete complex extravehicular tasks.
(3) A multimodal telerobotic control method of pose control, voice control, and force control is integrated with the robot's autonomous control through a shared control algorithm, and dimensions and weights of an outputted command of each control method that are mapped to a joint space of the robotic arms are dynamically distributed according to the operator's needs, such that position, posture and contact force of the robot-arms are realized through a human-robot shared control, allowing the operator to focus on controlling the robotic arms to perform critical and difficult operations, and the robot to autonomously complete simpler tasks, therefore, workload of the operator is reduced, and the accuracy and efficiency of teleoperation are improved.
(4) The local-site system provides multimodal feedback haptic, visual, and auditory sensations, which can improve the operator's sense of presence, control accuracy and comfort in unstructured environments.
(5) By incorporating the incremental control module, the teleoperation mapping parameter adjustment module, and the robotic arm collision detection and warning module into the system design, the human-robot interaction function meet practical application needs, and can greatly improves the safety and practicality of the system.

### BRIEF DESCRIPTION OF THE DRAWINGS

FIG. 1 is a structural block diagram of a multimodal shared telerobotic system for a three-arm space robot according to the present disclosure.

FIG. 2 is a schematic diagram of a mechanical structure of a three-arm space robot according to Embodiment 4 of the present disclosure.

FIG. 3 is a structural schematic diagram of a force-feedback haptic device according to Embodiment 4 of the present disclosure.

FIG. 4 is a schematic diagram of local-site virtual simulation human-robot interaction software according to Embodiment 4 of the present disclosure.

Reference numerals in the accompanying drawings: 1. left robotic arm; 2. structured-light camera; 3. robot platform; 4. right robotic arm; 5. connecting bearing; 6. observation arm; 7. stereo camera; 8. right robotic arm collision warning; 9. teleoperation mapping parameter adjustment panel; 10. left robotic arm collision warning; 11. main menu panel; 12. observation arm collision warning; 13. voice command display panel; 14. robotic-arm important information display interface; 15. robot platform collision warning; 16. emergency stop button; 17. handle of force-feedback haptic device; 18. first button of force-feedback haptic device; and 19. second button of force-feedback haptic device.

### DETAILED DESCRIPTION OF THE EMBODIMENTS

The present disclosure will be further illustrated below with reference to the accompanying drawings and specific embodiments. It should be understood that the following specific embodiments are only used to illustrate the present disclosure, but are not intended to limit the scope of the present disclosure.

### Embodiment 1

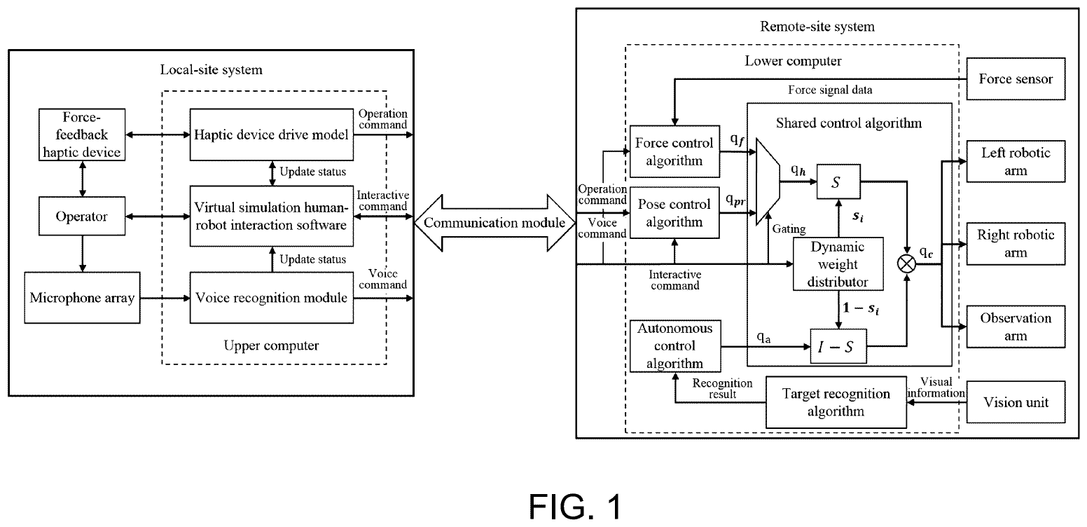

A multimodal shared telerobotic system for a three-arm space robot, as shown in FIG. 1, includes at least a local-site system, a communication module, and a remote-site system, where the communication module consists of a router and local-remote communication software, which constructs a medium-short distance and low-latency wireless local area network to achieve wireless communication between the local-site system and the remote-site system.

The local-site system at least includes two force-feedback haptic devices for left and right hands, a microphone array, and upper computer software. Geomagic Touch haptic devices are used as the force-feedback haptic devices and are configured to collect pose information in a Cartesian space inputted by an operator, receive data from force sensors and give feedback of three-dimensional force to the operator; the microphone array is configured to collect audio signals of the operator, and has functions of noise reduction and echo cancellation; and the upper computer software includes virtual simulation human-robot interaction software, a haptic device drive module, and a voice recognition module; and
specifically, the virtual simulation human-robot interaction software is developed using Unity and includes a real-time rendered robot three-dimensional model, teleoperation mapping parameter adjustment, and collision detection and warning functions, which can provide the operator with visual, tactile, and auditory multimodal feedback information and rich graphical interface, and output an interactive command; the haptic device drive module is configured to solve the inputted pose information of the operator and output the same as an operation command, and has an incremental control function; and the voice recognition module is a well-trained offline neural network and is configured to analyze and output a voice command of the operator.

The remote-site system includes two robotic arms provided with end-effectors, an observation arm with a stereo camera installed at an end thereof, two force sensors, a vision unit and lower computer software, both of the robotic arms use six-degree-of-freedom robotic arms, the two robotic arms are installed on shoulders of the robot, and grippers are installed at ends of the robotic arms for performing operational tasks; the observation arm is installed on a waist of the robot, and the stereo camera is installed at an end of the observation arm to provide the operator with a local view outside the vision unit; the force sensors are respectively installed at wrists of the two robotic arms, use six-dimensional force sensors, and are configured to collect and give feedback of force information generated during a contact between the end-effectors and an environment, as well as to give feedback of force information of a force control function of the robotic arms; the vision unit consists of a structured-light camera installed on a head of the robot and a stereo camera installed at the end of the observation arm, and is configured to provide a local-site system with visual information about a surrounding environment of a remote-site robot, and support target recognition of the autonomous control algorithm; and the lower computer software includes a force control algorithm, a pose control algorithm, a target recognition algorithm and a shared control algorithm, specifically:
the force control algorithm is used to control action force between the robotic arms and the surrounding environment, and to output a force control command q_{f} according to a force signal setting value in the interactive command outputted by the local-site system and data from the force sensors;
the pose control algorithm is used to control poses of the robotic arms and the observation arm, and is capable of reading a haptic device operation command, the voice command and the interactive command outputted by the local-site system, and outputting a pose control command qₚᵣ;
the target recognition algorithm is used to identify a target object in the environment and determine pose and contour of the target object; first of all, a view of the structured-light camera on the head of the robot is spliced with a view of the stereo camera on the observation arm based on cloud point of RGB image texture; a DBSCAN algorithm is then used to conduct cluster analysis to retain point cloud data with similar density; a DIC algorithm is then used to match image feature points to obtain point cloud contour and pose of the target object; and finally, a similarity detection is performed on recognition results Cᵢ are with an offline trained template and images under test to determine whether the target object is detected;
the autonomous control module is used to performs autonomous path planning based on target recognition result, and to generate a robot's autonomous command qₐ using a bidirectional rapidly-exploring random tree; and
the shared control algorithm is used to select the pose control command qₚᵣ or the force control command q_{f} as an operator's teleoperation command qₕ according to the interactive command, and integrate the operator's teleoperation command with the robot's autonomous command qₐ to obtain a final fusion command q_{c}; and a dynamic weight distributor is capable of dynamically distributing dimensions and weights of an outputted command of each method that is mapped to a joint space of the robotic arms through the interactive command according to the operator's needs, so as to realize human-robot shared control of position, posture and contact force of the robotic arms.

Through the multimodal shared telerobotic system, the operator can use the two force-feedback haptic devices inside a spacecraft cabin to separately control the two robotic arms of the robot outside the cabin for performing operations, and control the observation arm through the voice command to obtain a better local view; and a multimodal telerobotic control method of pose control, voice control, and force control is integrated with the robot's autonomous control through the shared control algorithm, such that the operator's workload is reduced and the control efficiency is improved.

### Embodiment 2

The difference between this embodiment and Embodiment 1 lies in that the local-site system further includes an incremental control module, a teleoperation mapping parameter adjustment module, and a robotic arm collision detection and warning module;
specifically, in the incremental control module, the pose information of the force-feedback haptic devices is transmitted to the haptic device drive module only when the operator presses buttons on handles of the force-feedback haptic devices, and the pose information will not be transmitted when the buttons are released; upon receiving a signal indicating the buttons release, the local-site system records current pose information of a task space of one end of any of the robotic arms; in which case, the operator can move the handles of the force-feedback haptic devices to an appropriate position, while the robotic arm remains stationary as it does not receive any signal; and when the operator presses the buttons, the robotic arms continue to move according to the operator's control. Therefore, the incremental control module adopts an interactive method like a mouse. When the operator releases the button on the handles of the force-feedback haptic devices, the end of any of the robotic arms will maintain its current pose unchanged, the operator can then move the handles of the force-feedback haptic devices to a suitable position and press the buttons again to continue controlling movements of any of the robotic arms, which is used to solve the problem of a limited control range caused by large difference in a working space range between the local-site force-feedback haptic devices and the remote-site robotic arm. Furthermore, when feeling uncomfortable in holding the force-feedback haptic device, the operator can make adjustment quickly, such that the operator's control accuracy and comfort are improved.

Since a spatial task is very difficult, rapid large-scale movements, precise small-scale operations, and flexible adjustments to a force feedback magnitude are required for the pose control of the robotic arms through the teleoperation mapping parameter adjustment module. The module supports astronauts inside the cabin to adjust a position ratio mapping parameter and a force mapping parameter in real time. Specifically, the position ratio mapping parameter is a ratio of movement scale of the handles of the force-feedback haptic devices to a movement scale of the robotic arms. The larger the position ratio mapping parameter is, the larger the scale of the robotic arms move. When the position ratio mapping parameter is 0, the robotic arms cannot move. The force mapping parameter can adjust feedback force provided by the haptic device when the end-effector of the robotic arm contacts the environment. The larger the force mapping parameter is, the stronger the feedback force provided by the haptic device becomes. When the force mapping parameter is 0, the force feedback will be 0; and

Principles and interactive method of the robotic arm collision detection and warning module are as follows:
the robotic arm collision detection and warning module is developed based on the Unity collider mechanism and is capable of detecting potential risks of collision in real time between the robotic arms, as well as between the robotic arms and a robot platform, during the movements of the robotic arms. In addition, the module can issue warnings through multimodal feedback methods such as auditory, visual, and haptic device. The collision warning is divided into two stages: pre-collision warning and alarm during collision.

The pre-collision warning is evidenced as follows: through the virtual simulation human-robot interaction software, a part of the robotic arm at a potential risk of collision is highlighted in yellow, warning music is played at the same time, a collision indicator light turns yellow, and a collision status is displayed as “too close”. In addition, the haptic device provides damping force in a direction of impending collision to remind the operator to stop moving the handle in the direction of impending collision, so as to achieve an effect of reminding the operator to move the handle in an opposite direction to avoid the collision.

The alarm during collision is evidenced as follows: through the virtual simulation human-robot interaction software, a part of the robotic arm that has suffered a collision is highlighted in red, collision alarm music is played at the same time, a collision indicator light turns red, and a collision status is displayed as “Collision detected”. The haptic device provides a strong repulsive force to remind the operator to quickly move the handle in the opposite direction.

By incorporating the incremental control module, the teleoperation mapping parameter adjustment module, and the robotic arm collision detection and warning module into the system design, the human-robot interaction function meet practical application needs, and can greatly improves the safety and practicality of the system.

### Embodiment 3

A multimodal shared telerobotic method for a three-arm space robot, which uses the system described in Embodiment 1, where the lower computer of the multimodal telerobotic system for a three-arm space robot integrates three methods, that is, pose control, force control, and autonomous control. Specifically, the pose control includes three methods, that is, haptic device control, voice control, and keyboard interactive control. The multimodal telerobotic method can be combined with the autonomous control to realize multimodal shared teleoperation.

Principles of the pose control are as follows:
step 1: powering on the system and initializing various parameters of each of the robotic arms, establishing IP communication, obtaining current pose information and kinematic parameters of each of the robotic arms, setting a base of each of the robotic arms as a task-space coordinate system, and performing forward kinematics pose relationship transformation based on the coordinate system; and using a Lagrangian formulation to establish a dynamic model for each of the robotic arms. Since the space robot operates is in a weightless environment, a gravity term is omitted, and nonlinear disturbance terms such as joint motor friction are simplified. A calculation formula is as follows:

$$τ + {J}^{T} ( q ) {F}_{e} = M ( q ) \ddot{q} + C ( q , \dot{q} ) \dot{q}$$

where M(q) is a mass matrix of the robotic arms, C(q, \dot{q}) is centrifugal force and Coriolis force matrix of the robotic arms, \dot{\ddot{q}} is an angular acceleration of each joint of each of the robotic arms, and \dot{q} is an angular velocity of each joint of each of the robotic arms;
step 2: reading a haptic device operation command, a voice command and an interactive command outputted by the local-site system in real time, parsing the above commands into a Cartesian target pose x_{d} of an end of each of the robotic arms via a local-remote operation space mapping, then obtaining a current joint angle qₜ of each of the robotic arms, solving a current Cartesian pose xₜ of the end of each of the robotic arms through forward kinematics, and finally obtaining an error term e(t)=x_{d}−xₜ; and
step 3: inputting e(t) is into a PID controller to iterate and obtain a pose u(t), with a calculation formula as follows:

$$u ( t ) = {K}_{p} e ( t ) + {K}_{i} {\int }_{0}^{t} e ( t ) d t + {K}_{d} \frac{de ( t )}{dt}$$

obtaining a new joint angle qₜ₊₁ of each of the robotic arms through inverse kinematics of an iterative pose u(t); performing forward kinematics in a next cycle to obtain xₜ₊₁, calculating an error term between it and the target pose x_{d}, inputting the error term into the PID controller to form a closed loop, outputting a pose control command qₚᵣ after N iterations, which greatly improves the control accuracy of robotic arms. In addition, the system performance such as steady-state error, response speed, and overshoot, can be optimized by adjusting a number of iterations and various PID parameters.

Principles of the force control are as follows:
step 1: performing initialization same as that in the step 1 of the pose control;
step 2: setting a target six-dimensional force signal F_{d} for each of the robotic arms through the local-site system, reading a current force signal Fₜ of the force sensor at the end of each of the robotic arms, calculating an error term between the F_{d} and the Fₜ and inputting the error term into the PID controller to generate a iterative force signal Fₑ, and obtaining a force control command q_{f} through the dynamic model;
step 3: in a next cycle, calculating an error between a force signal Fₜ₊₁ from each of the force sensors and the F_{d}, substituting the error term into the PID controller, combining a current Jacobian matrix J^{T}(q) of each of the robotic arms to form a closed loop of control, similar to the pose control, and obtaining a new force control command q_{f+1} by iteration to complete the precise force control of the robotic arms.

Principles of the autonomous control are specifically as follows:
step 1: taking the pose at the end of each of the robotic arms as a root node of a first extended random tree, determining a pose of the target according to recognition results of a target recognition algorithm, and taking the pose of the target as a root node of a second extended random tree;
step 2: performing alternating bidirectional expansion of the two extended random trees using a same step size through a random sampling method, adding sub-nodes alternately until the two trees meet, at which point a path planning algorithm converges; and
step 3: after the path planning algorithm converges, performing backtrack along the root nodes at an intersection of the two extended random trees to identify a valid path, performing inverse kinematics of a series of sub-nodes on the valid path to obtain a value of a joint angle in a joint space of the robotic arms, and outputting an autonomous command qₐ.

A calculation formula of the shared control algorithm is as follows:

$${q}_{c} = S {q}_{h} + ( I - S ) {q}_{a}$$

where S=diag[s₁, s₂, s₃, s₄, s₅, s₆]^{T}, sᵢ∈[0,1] and S matrix is a six-dimensional diagonal weight matrix, which represents dimensions and weights of the autonomous control commands mapping in the joint space of the robotic arms, I is a six-dimensional identity matrix qₕ, qₐ and q_{c} are all 6×1 matrices, and q_{c} represents a fusion command; and
a value of S can be determined by a dynamic weight distributor:
1) when the target recognition algorithm does not detect the target object, or the target recognition result Cᵢ is lower than a recognition threshold C_{L}, the dynamic weight distributor sets S as an identity matrix, in which case, the operator fully controls pose and force of the robotic arms using the haptic devices or via keyboard interaction, and controls pose of the observation arm via a voice command;
2) when the target recognition result Cᵢ is greater than or equal to the recognition threshold C_{L}, a value of S is calculated via the dynamic weight distributor based on a task type through the interactive command set by the operator in the local-site system, such that position, posture and contact force of human-robot shared control are realized. For example, the operator can use the voice command to control a position of the observation arm via the voice command, and the robot can autonomously adjust the pose of the observation arm, such that the observation arm can automatically align with the target object to obtain a better local view, alternatively, the operator can control the pose of the robotic arms, such that the robot can autonomously control action force exerted by the end of the robotic arms on the environment; and
3) when the target recognition result Cᵢ is greater than or equal to the recognition threshold C_{L}, and S is set to a zero matrix, such that the robot fully and autonomously controls the pose and force of the robotic arms.

Specific implementation steps of the shared control algorithm are as follows:
step 1: before actual operation, selecting either the pose control command qₚᵣ or a force control command q_{f} via the interactive command as a teleoperation command qₕ according to an operation mode set by the operator;
step 2: sending a local-site interactive command to the dynamic weight distributor to calculate a value of each diagonal element of a weight matrix S according to target recognition result Cᵢ and a type of operation task, so as to realize dynamic updating of shared control weights during an operation process;
step 3: fusing the teleoperation command qₕ of the operator and the autonomous command qₐ of the robot to obtain a final fusion command q_{c} according to calculation results S of the dynamic weight distributor.

### Embodiment 4

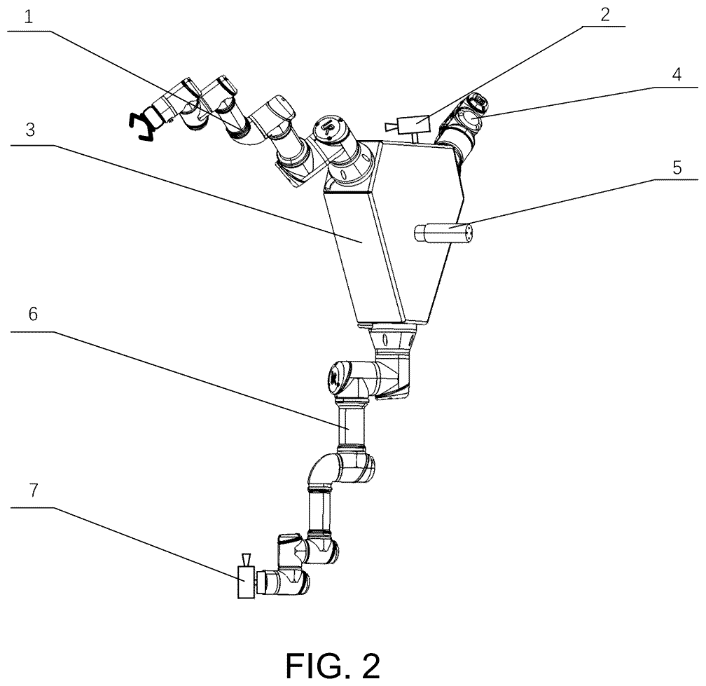

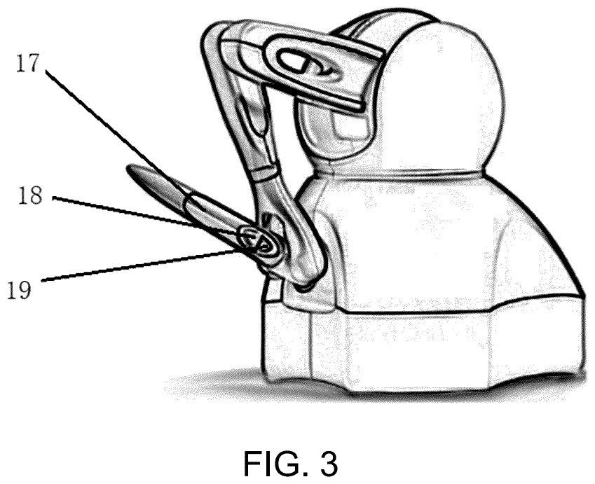

This embodiment is practical application of the system and method provided in the present disclosure, that is, a multimodal shared telerobotic system for a three-arm space robot, where the three-arm space robot has a structure shown in FIG. 2, the three-arm space robot is fixed to a large robotic arm outside a space station cabin via a connecting bearing 5, a power supply line of the space robot is connected to a robot platform 3 via the connecting bearing 5, and a control circuit and a communication module of the space robot are installed inside the robot platform 3. FIG. 3 is a structural schematic diagram of a force-feedback haptic device.

In a spacecraft cabin, an operator uses handles 17 of the two force-feedback haptic devices to control a left robotic arm 1 and a right robotic arm 4 of the space robot outside the cabin to perform tasks, and uses first buttons 18 of the force-feedback haptic devices to control opening and closing of grippers on the left robotic arm 1 and the right robotic arm 4. A microphone array is configured to collect voice commands of the operator, an observation arm 6 is controlled via the voice commands, and a stereo camera 7 installed at one end of the observation arm is configured to obtain a better local view. The operator obtains visual information of a surrounding environment of the robot via a structured-light camera 2 installed on the robot platform 3 and the stereo camera 7 at the end of the observation arm 6, and the visual information is transmitted via the communication module to local-site virtual simulation human-robot interaction software and is used by an autonomous control module for target recognition.

Specific implementation mode of the incremental control is as follows: when the operator presses second buttons 19 of the force-feedback haptic devices, pose information of the handles 17 of the force-feedback haptic devices, the pose information of the handles 17 of the force-feedback haptic devices is transmitted to the haptic device drive module, and the pose information will not be transmitted when the buttons 19 are released; upon receiving a signal indicating the buttons 19 release, the local-site system records current pose information of a task space of the left robotic arm 1 and the right robotic arm 4; in which case, the operator can move the handles of the force-feedback haptic devices to an appropriate position, and the left robotic arm 1 and the right robotic arm 4 remain stationary as they do not receive any signal; and when the operator presses the buttons 19, the left robotic arm 1 and the right robotic arm 4 continue to move according to the operator's control.

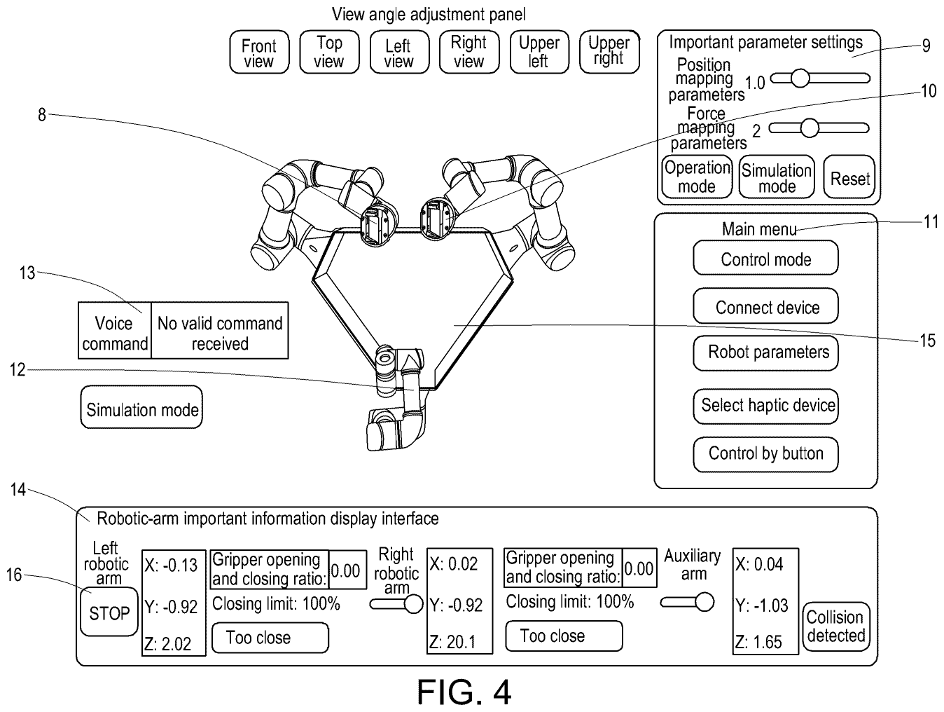

In the present disclosure, the virtual simulation human-robot interaction software is developed using Unity, as shown in FIG. 4, the virtual simulation human-robot interaction software includes a real-time rendered robot three-dimensional model, teleoperation mapping parameter adjustment, and collision detection and warning functions, which can provide the operator with visual, tactile, and auditory multimodal feedback information and rich graphical interface, and output an interactive command.

The operator adjusts a position ratio mapping parameter and a force mapping parameter in real time via a teleoperation mapping parameter adjustment panel 9 on an interactive interface. Specifically, the position ratio mapping parameter is a ratio of movement scale of the handles 17 of the force-feedback haptic devices to a movement scale of the robotic arms. The larger the position ratio mapping parameter is, the larger the scale of the robotic arms move. When the position ratio mapping parameter is 0, the robotic arms cannot move. The force mapping parameter can adjust feedback force provided by the haptic device when the end-effector of the robotic arm contacts the environment. The larger the force mapping parameter is, the stronger the feedback force provided by the haptic device becomes. When the force mapping parameter is 0, the force feedback will be 0.

In the specific operation, the operator uses various submenus in a main menu panel 11 to set a robotic arm control mode, configure a shared control weight, set an interactive command of a force control target value, read parameters of the robotic arms, and perform keyboard interaction to control the pose of the robotic arms, and send the interactive command via a communication module to a remote-site pose control algorithm, a force control algorithm, and a shared control algorithm, thereby realizing the multimodal shared teleoperation of the three-arm space robot. At the same time, the operator can obtain real-time position and status information of each of the robotic arms via a robotic-arm important information display interface 14 of the virtual simulation human-robot interaction software, and use the robotic arm collision detection and warning module developed based on the Unity collider mechanism to detect potential risks of collision in real time between the robotic arms, as well as between the robotic arms and the robot platform 3, during the movements of the robotic arms. In addition, the module can issue warnings through multimodal feedback methods such as auditory, visual, and haptic device. The collision warning is divided into two stages: pre-collision warning and alarm during collision, so as to avoid collisions between the robot arms during operation and ensure the safety of the system. As shown in FIG. 3, an end of the right robotic arm 4 of the robot is about to collide with the left robotic arm 1, and a part of the robotic arm at a potential risk of collision is highlighted: a right robotic arm collision warning 8 and a left robotic arm collision warning 10. At the same time, the human-robot interaction software plays warning music, and collision indicator lights for the left and right robotic arms on the robotic-arm important information display interface 14 turn yellow, and a collision status is displayed as “too close”. In addition, the haptic device provides damping force in a direction of impending collision to remind the operator to stop moving the handle in the direction of impending collision, so as to achieve an effect of reminding the operator to move the handle in an opposite direction to avoid the collision.

In the specific operation, when a collision occurs, that is, the observation arm 6 and the robot platform 3 have collided, a part of the robotic arm that has suffered a collision is highlighted, an observation arm collision warning 12 and a robot platform collision warning 15, and the human-robot interaction software play collision alarm music, an observation arm collision indicator light on the robotic-arm important information display interface 14 turns red, and a collision status is displayed as “Collision detected”. The haptic device provides a strong repulsive force to remind the operator to quickly move the handle in the opposite direction. The operator can press an emergency stop button 16 to stop the data communication between the local-site system and the remote-site system and terminate all movement commands of the robotic arms to prevent further collision damage.

Specific implementation of the multimodal shared teleoperation includes the following steps:
step 1: before actual operation is performed, setting operation modes of the two robotic arms via a main menu 11 of the virtual simulation human-robot interaction software and sends the operation modes to shared control. When pose control is selected, a pose control command qₚᵣ is outputted as a teleoperation command qₕ of the operator; and when force control is selected, a force control command q_{f} is outputted as the teleoperation command qₕ of the operator; and
step 2: sending a local-site interactive command to the dynamic weight distributor to calculate a value of each diagonal element of a weight matrix S according to video feedback from a vision unit, a target recognition result Cᵢ and a type of operation task, so as to realize dynamic updating of shared control weights during an operation process, with the updating steps as follows:
1) when the target recognition algorithm does not detect the target object, or the target recognition result Cᵢ is lower than a recognition threshold C_{L}, the a dynamic weight distributor sets S as an identity matrix, in which case, the operator fully controls pose and force of the robotic arms using the haptic devices or via keyboard interaction, and controls pose of the observation arm 6 via the voice command; and a latest voice command and a completion status of the command will be displayed on a voice command display panel 13;
2) when the target recognition result Cᵢ is greater than or equal to the recognition threshold C_{L}, a value of S is calculated via the dynamic weight distributor based on a task type through the interactive command set by the operator in the local-site system, such that position, posture and contact force of human-robot shared control are realized. For example, the operator can use the voice command to control a position of the observation arm 6 via the voice command, and the robot can autonomously adjust the pose of the observation arm 6, such that the observation arm can automatically align with the target object to obtain a better local view, alternatively, the operator can control the pose of the robotic arms, such that the robot can autonomously control action force exerted by the end of the robotic arms on the environment; and
3) when the target recognition result Cᵢ is greater than or equal to the recognition threshold C_{L}, and S is set to a zero matrix, such that the robot fully and autonomously controls the pose and force of the robotic arms;
step 3: fusing the teleoperation command qₕ of the operator and an autonomous command qₐ of the robot according to calculation results S of the dynamic weight distributor to obtain a final fusion command q_{c}, and distributing dimensions and weights of the teleoperation command qₕ and the autonomous command qₐ mapping in a joint space of the robotic arms, so as to realize human-robot shared control of position, posture and contact force of the robotic arms, with a fusion formula as follows:

$${q}_{c} = S {q}_{h} + ( I - S ) {q}_{a} .$$

n summary, the method of the present disclosure uses the two robotic arms of the three-arm space robot, which is more convenient and flexible to operate the robot, and a better local view can be obtained by controlling the observation arm 6 through the voice function. A hybrid control strategy allows the operator to directly control the system, leveraging his/her judgment and decision-making ability, while ensuring that the robot has a certain degree of autonomy, and the robot can help the operator complete complex extravehicular tasks, allowing the operator to focus on controlling the robotic arms to perform critical and sophisticated operations, while the robot can autonomously complete simpler tasks. Therefore, the system and method of the present disclosure can reduce workload of the operator and improve the accuracy and efficiency of teleoperation.

In the description of the present disclosure, reference to terms “one embodiment”, “examples”, “specific examples”, and the like means that a specific feature, structure, material or characteristic described in combination with the embodiment are included in at least one embodiment or example of the present disclosure. In the description, the schematic descriptions of the above terms do not necessarily refer to the same embodiment or example. Moreover, the specific feature, structure, material or characteristics described may be combined in a suitable manner in any one or more embodiments or examples.

It should be noted that the above content merely illustrates the technical idea of the present disclosure and cannot limit the protection scope of the present disclosure, those ordinarily skilled in the art may also make some modifications and improvements without departing from the principle of the present disclosure, and these modifications and improvements should also fall within the protection scope of the claims of the present disclosure.

What is claimed is:

1. A multimodal shared telerobotic system for a three-arm space robot, at least comprising a local-site system, a communication module, and a remote-site system; wherein
the local-site system at least comprises two force-feedback haptic devices for left and right hands, a microphone array, and an upper computer software; and the upper computer software at least comprises a virtual simulation human-robot interaction software, a haptic device drive module, and a voice recognition module;
the remote-site system comprises robotic arms, an observation arm, force sensors, a vision unit and a lower computer software, the robotic arms have two and is provided with a gripper at an end thereof; a stereo camera is installed at an end of the observation arm; the lower computer software at least comprises a force control algorithm, a pose control algorithm, a target recognition algorithm, an autonomous control algorithm and a shared control algorithm; and the vision unit is configured to provide the local-site system with visual information about a surrounding environment of a remote-site robot, and support target recognition of the autonomous control algorithm; and
the communication module is configured to construct a medium-short distance and low-latency wireless local area network to achieve wireless communication between the local-site system and the remote-site system.

2. The multimodal shared telerobotic system for the three-arm space robot according to claim 1, wherein in the local-site system:
the force-feedback haptic devices are configured to collect pose information inputted by an operator, receive data from the force sensors and give feedback of three-dimensional force to the operator;
the microphone array is configured to collect audio signals of the operator;
the virtual simulation human-robot interaction software comprises a real-time rendered robot three-dimensional model, teleoperation mapping parameter adjustment, and collision detection and warning functions, which can provide the operator with feedback information and an interactive interface, and output an interactive command;
the haptic device drive module is configured to solve a inputted pose information of the operator and output the same as an operation command; and
the voice recognition module is configured to analyze and output a voice command of the operator.

3. The multimodal shared telerobotic system for the three-arm space robot according to claim 1, wherein in the lower computer software:
the force control algorithm is used to control action force between the robotic arms and the surrounding environment, and to output a force control command q_{f} according to a force signal setting value in the interactive command outputted by the local-site system and data from the force sensors;
the pose control algorithm is used to control poses of the robotic arms and the observation arm, and is capable of reading a haptic device operation command, the voice command and the interactive command outputted by the local-site system, and outputting a pose control command qₚᵣ;
the target recognition algorithm is used to identify a target object in the environment and determine pose and contour of the target object;
an autonomous control module is used to performs autonomous path planning based on target recognition result, and to generate a robot's autonomous command qₐ using a bidirectional rapidly-exploring random tree; and
the shared control algorithm is used to select the pose control command qₚᵣ or the force control command q_{f} as an operator's teleoperation command qₕ according to the interactive command, and integrate an operator's teleoperation command with the robot's autonomous command qₐ to obtain a fusion command q_{c} and a dynamic weight distributor is capable of dynamically distributing dimensions and weights of an outputted command of each method that is mapped to a joint space of the robotic arms through the interactive command, so as to realize human-robot shared control of position, posture and contact force of the robotic arms.

4. The multimodal shared telerobotic system for the three-arm space robot according to claim 2, wherein the local-site system further comprises an incremental control module, a teleoperation mapping parameter adjustment module, and a robotic arm collision detection and warning module;
the incremental control module enables and controls movements of the robotic arms through buttons on handles of the force-feedback haptic devices;
the teleoperation mapping parameter adjustment module is configured to adjust locate-site and remote-site position ratio mapping parameters and force mapping parameters, and adjust movement step sizes of the robotic arms and magnitude of feedback force provided by the force-feedback haptic devices; and
the robotic arm collision detection and warning module is configured to detect potential risks of collision in real time between the robotic arms, as well as between the robotic arms and a robot platform during the movements of the robotic arms, and to issue a warning.

5. A multimodal shared telerobotic method for the three-arm space robot of a system according to claim 1, wherein when an operator controls the remote-site robot with two robotic arms and one observation arm to perform tasks through local-site and the remote-site system, a lower computer outputs control commands of three methods, such as posture control, force control and autonomous control, to the shared control algorithm to realize a control of the robotic arms, wherein
when a pose control is performed, a command outputted by the local-site system can be read in real time, the command is parsed into a Cartesian target pose x_{d} of an end of each of the robotic arms via a local-remote operation space mapping, a current joint angle qₜ of each of the robotic arms is then obtained, a current Cartesian pose xₜ of the end of each of the robotic arms through forward kinematics, and an error term e(t)=x_{d}−xₜ is obtained; the error term e(t) is inputted to a control to iterate and obtain a pose u(t), a new joint angle qₜ₊₁ of each of the robotic arms is obtained through inverse kinematics of an iterative pose u(t); forward kinematics is performed in a next cycle to obtain xₜ₊₁, an error between it and a target pose x_{d} is calculated, the error term is inputted into a Proportional-Integral-Derivative (PID) controller to form a closed loop of control, and a pose control command qₚᵣ after N iterations is obtained; and
when a force control is performed, the operator sets a target six-dimensional force signal F_{d} for each of the robotic arms through the local-site system, reads a current force signal Fₜ of the force sensors at the end of each of the robotic arms, calculates an error term between the F_{d} and the Fₜ and inputs the error term into the PID controller to generate a iterative force signal Fₑ, and obtain a force control command q_{f} through a dynamic model; and the operator calculates an error between a force data signal Fₜ₊₁ from each of the force sensors and the F_{d} in a next cycle, substitutes the error term into the PID controller, combining a current Jacobian matrix J^{T}(q) of each of the robotic arms to form a closed loop of control, similar to the pose control, and obtains a new force control command q_{f+1}; and
when an autonomous control is performed, a pose at the end of each of the robotic arms is taken as a root node of a first extended random tree, a pose of a target object is determined according to recognition results of the target recognition algorithm, and the pose of the target object is taken as a root node of a second extended random tree; alternating bidirectional expansion of two extended random trees is performed using a same step size through a random sampling method, sub-nodes are added alternately until the two extended random trees meet, at which point a path planning algorithm converges; and after the path planning algorithm converges, backtrack is performed along root nodes at an intersection of the two extended random trees to identify a valid path, and inverse kinematics of a series of sub-nodes is performed on the valid path to obtain a value of a joint angle in a joint space of the robotic arms, which is outputted as an autonomous command qₐ.

6. The multimodal shared telerobotic method for the three-arm space robot according to claim 5, wherein for the three methods integrating the pose control, the force control and the autonomous control, the shared control algorithm comprises the following steps:
step S1: selecting either the pose control command qₚᵣ or the force control command q_{f} via an interactive command as a teleoperation command qₕ according to an operation mode set by the operator;
step S2: sending a local-site interactive command to a dynamic weight distributor to calculate a value of each diagonal element of a weight matrix S according to target recognition result Cᵢ and a type of operation task, so as to realize dynamic updating of shared control weights during an operation process; and
step S3: fusing the teleoperation command qₕ of the operator and the autonomous command qₐ of the robot to obtain a final fusion command q_{c} according to calculation results S of the dynamic weight distributor.

7. The multimodal shared telerobotic method for the three-arm space robot according to claim 6, the weight matrix S in the step S2 is determined by the dynamic weight distributor:
when the target recognition algorithm does not detect the target object, or the target recognition result Cᵢ is lower than a recognition threshold C_{L}, dynamic weight distributor sets S as an identity matrix, in which case, the operator controls pose and force of the robotic arms using the haptic devices or via keyboard interaction, and controls pose of the observation arm via a voice command;
when the target recognition result Cᵢ is greater than or equal to the recognition threshold C_{L}, a value of S is calculated via the dynamic weight distributor based on a task type through the interactive command set by the operator in the local-site system, such that position, posture and contact force of human-robot shared control are realized; and
when the target recognition result Cᵢ is greater than or equal to the recognition threshold C_{L}, and S is set to a zero matrix, such that the robot fully and autonomously controls the pose and force of the robotic arms.

8. The multimodal shared telerobotic system for the three-arm space robot according to claim 3, wherein the local-site system further comprises an incremental control module, a teleoperation mapping parameter adjustment module, and a robotic arm collision detection and warning module;
the incremental control module enables and controls movements of the robotic arms through buttons on handles of the force-feedback haptic devices;
the teleoperation mapping parameter adjustment module is configured to adjust locate-site and remote-site position ratio mapping parameters and force mapping parameters, and adjust movement step sizes of the robotic arms and magnitude of feedback force provided by the force-feedback haptic devices; and
the robotic arm collision detection and warning module is configured to detect potential risks of collision in real time between the robotic arms, as well as between the robotic arms and a robot platform during the movements of the robotic arms, and to issue a warning.
